(19) United States
(12) Patent Application Publication
(10) Pub. No.: US 2024/0005253 A1
(43) Pub. Date: Jan. 4, 2024

(54) SUSTAINABILITY VALIDATION SYSTEMS, APPARATUS, AND METHODS

(71) Applicant: AYRO, Inc., Round Rock, TX (US)

(72) Inventor: Thomas M. Wittenschlaeger, Sarasota, FL (US)

(21) Appl. No.: 17/810,503

(22) Filed: Jul. 1, 2022

(51) Int. Cl. G06Q 10/06

(52) U.S. Cl. CPC G06Q 10/06393

(57) ABSTRACT

A vehicular sustainability ecosystem is disclosed. Vehicles manufactured or used according to sustainability criteria may be characterized via a sustainability vector that satisfies the sustainability criteria. Further, a vehicles sustainability may be validated by one or more computer systems that measure the sustainability of the vehicle, possibly in real-time. Based on the satisfaction level of the sustainability criteria, the computer system may cause other devices, including the vehicle itself, to take corrective actions.

### FIELD OF THE INVENTION

The field of the invention is technologies related to determining the sustainability of manufactured goods, especially vehicles.

### BACKGROUND

The background description includes information that may be useful in understanding the present inventive subject matter. It is not an admission that any of the information provided herein is prior art or applicant admitted prior art, or relevant to the presently claimed inventive subject matter, or that any publication specifically or implicitly referenced is prior art or applicant admitted prior art.

An incredible amount of effort has been directed to optimizing vehicles, especially with respect to production, performance, or other factors. Many such efforts have focused on managing one or more aspects of a vehicle to ensure that it is fit for use. For example, consider European Patent publication 3,792,124 to Aubert et al. titled “Method for controlling an autonomous vehicle including discretisation of environmental data”, filed Apr. 9, 2020. This publication describes using multiple elements of a vehicle (e.g., speed, weight, etc.) as a state vector to optimize navigation of an autonomous vehicle.

Another vehicular optimization example includes U.S. patent publication 2022/0089237 to Sverdlov et al. titled “Robotic Production Environment for Vehicles,” filed Jun. 16, 2021. This example does not focus on vehicular performance, but rather vehicular production that may include manufacturing vehicles that are produced for specific purposes. While such efforts address needs for ensuring a vehicle meets the design goals for its specific purpose, there is still room for further improvements in regard to managing multiple aspects of a vehicle.

More specifically and more interestingly, the known art fails to appreciate that there are additional aspects of a vehicle that are important beyond operational or design goals. Further, as referenced above the art still focus on specific purpose-built machines. For example, sustainability of vehicles may be improved beyond mere adherence to design goals. As described below with regards to the inventor's work, sustainability itself may have many different dimensions that may impact the use of a vehicle, including the sustainability of a vehicle at a moment of use rather than just at point of manufacture. Thus, a myriad of sustainability traits of a vehicle should be managed to ensure the vehicle not only satisfies sustainability requirements, but also is able to stay within the scope of sustainability criteria during the vehicle's full lifetime from production, to use, or even to end-of-life (e.g., recycling, upcycling, etc.).

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member may be referred to and claimed individually or in any combination with other members of the group or other elements found herein. One or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is a need for managing and improving sustainability of a vehicle, for example, in a given context or in real-time.

### SUMMARY

The inventive subject matter provides apparatus, systems, and methods in which a vehicle may be characterized by its sustainability footprint. In some embodiments, a vehicle comprises or is characterized by a set of or a plurality of measurable traits of the vehicle. The vehicle itself may be considered as having a multi-dimensional sustainability vector, possibly stored in a computer readable memory. The sustainability vector further includes measured values corresponding to at least some of the measurable traits taken from the vehicle. The measured values may comprise sensed values from one or more sensors or even empirical values taken by physical measurements. Some of the measurable traits may be correlated (e.g., length and weight) while others may be uncorrelated (e.g., color and noise). Still further the vehicle may be characterized by the sustainability vector satisfying one or more sustainability criteria, possibly that are a priori defined. Such criteria may be defined as part of a sustainability certification process.

Yet another aspect of the inventive subject matter comprises a computer-based vehicular sustainability validation system that may be designed to determine the sustainability fitness of an actual vehicle, possibly at any point in the vehicles lifetime. The system comprises one or more computer readable memories (e.g., flash, RAM, etc.) storing one or more measurable traits of a vehicle and validation software instructions. The system further includes one or more processors (e.g., CPU, multi-core processor, etc.) coupled with the memory and able to conduct multiple operations upon execution of the validation software instructions. The operations may include obtaining one or more stored measured values for the measurable traits of the vehicle. The stored measured values may be obtained from one or more sensors (e.g., cell phone camera, scales, microphones, accelerometers, etc.) or may be inputted into the memory. The operations further include generating, preferably in the memory, at least one sustainability vector having multiple sustainability dimensions as a function of the stored measured values. In some scenarios the sustainability vector reflects a current or real-time context of the vehicle. Therefore, zero, one, two or more sustainability vectors could be considered “active” at any given time, which provides for context-based optimization, possibly balanced against, or weighted by a current utility of the vehicle. Further, the operations include obtaining sustainability criteria, possibly as part of a sustainability standard, that operate on the sustainability vector. Continuing forward, the operations may also include determining a satisfaction level according to the sustainability criteria operating on the sustainability vector. The satisfaction level may be indicative of the vehicle satisfying the criteria, failing to satisfy the criteria, or to what degree the vehicle satisfies or doesn't satisfy the criteria. Thus, the results of determining the satisfaction level may include one or more devices taking actions as triggered by or according to the satisfaction level. For example, the operations may further include causing one or more output devices (e.g., computers, tablets, phones, the vehicle itself, etc.) to generate a notification relating to the satisfaction level. Example notifications may include sending a message over a network, calling an API, rendering a webpage, causing the vehicle to take actions, or other type of electronic communication.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an overview of traits of a low-speed vehicle (LSV) and that relate to sustainability.

FIG. 2 provides an overview of a sustainability space and sustainability vectors including measurable traits with measured values.

FIG. 3 illustrates differences between correlated traits and uncorrelated traits.

FIG. 4 provides a schematic of a sustainability validation computer system in a validation ecosystem.

FIG. 5 presents a computer implemented method of validating a sustainability of a vehicle.

FIG. 6A presents a pickup LSV bed guard configuration according to aspects of the inventive subject matter.

FIG. 6B presents two additional pickup LSV bed guard configurations having reduced weight according to aspects of the inventive subject matter.

FIG. 6C presents two additional pickup LSV bed guard configurations having reduced weight and alternative materials according to aspects of the inventive subject matter.

FIG. 6D presents two additional pickup LSV bed guard configurations having reduced weight and additional storage packs according to aspects of the inventive subject matter.

### DETAILED DESCRIPTION

It should be noted that any language directed to a computer should be read to include any suitable combination of computing devices, including servers, interfaces, systems, databases, agents, peers, engines, controllers, modules, or other types of computing devices operating individually or collectively. One should appreciate the computing devices comprise at least one processor configured to execute software instructions stored on a tangible, non-transitory computer readable storage medium (e.g., hard drive, FPGA, PLA, solid state drive, RAM, flash, ROM, etc.). The software instructions configure or program the computing device to provide the roles, responsibilities, or other functionality as discussed below with respect to the disclosed apparatus. Further, the disclosed technologies may be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices may be conducted over a packet-switched network, the Internet, LAN, WAN, VPN, or other type of packet switched network; a circuit switched network; cell switched network; or other type of network.

As used in the description herein and throughout the claims that follow, when a system, engine, server, device, module, or other computing element is described as configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

One should appreciate that the disclosed techniques provide many advantageous technical effects including having a real-world impact on a vehicle to ensure the vehicle's design, functionality, or operational features stay within sustainability requirements over the lifetime of the vehicle from design, manufacture, use, and through to end-of-life. For example, when a vehicle's sustainability profile fails to satisfy sustainability criteria, changes to the sustainability profile may be identified and used to change the nature of the vehicle. Alternatively, when a vehicle's sustainability profile satisfies sustainability criteria, especially within a given context, the vehicle's sustainability traits may be archived for audit reasons, for example.

The focus of the disclosed inventive subject matter is to enable construction or configuration of physical vehicles, especially electric low speed vehicles (LSVs) and to enable a computing device to operate on vast quantities of digital data, beyond the capabilities of a human to ensure the disclosed vehicles retain their sustainability attributes throughout the lifetime of the vehicles. Although disclosed digital data represents a vehicle or its measured sustainability, it should be appreciated that the digital data gives rise to altering the vehicle or to engaging one or more computing devices. By instantiation of vehicle models or sustainability digital models in the memory of the computing devices, the computing devices are able to manage the digital data in a manner that provide utility to a vehicle user, designer, manufacturer, regulatory agencies, or other entity engaged with such vehicles.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

As a brief introduction, the following discussion relates to managing the sustainability of a vehicle, more specifically electric Low Speed Vehicles (LSVs). Each vehicle may be considered to have one or more measurable trait, where each type of trait may be considered a dimension of sustainability. Measured values of the traits may be compiled into a vector, or other data structure, to represent a more complete picture of the vehicle's actual sustainability. The sustainability vector may be evaluated against sustainability criteria to determine if the vehicle is indeed adhering to its sustainability goals at any given time. Thus, in one embodiment, the inventive subject matter comprises a vehicle characterized by the vehicle's sustainability vector. In another embodiment, the inventive subject matter may comprise a computer-based sustainability validation system that determines how well the vehicle satisfies one or more sustainability criteria, possibly at any given point in time. Still, in more preferred embodiments, sustainability must be juxtaposed against utility so that the utility of the vehicle is not lost while enforcing sustainability.

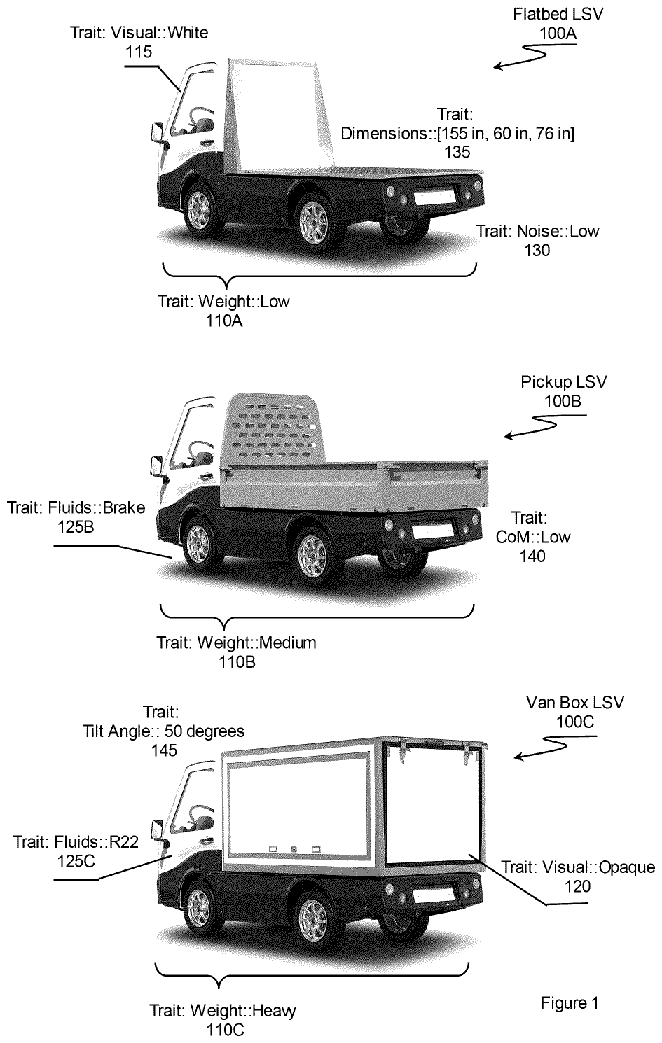

FIG. 1 presents three different versions of an LSV, collectively referred to as LSVs 100, where each version represents a possible configuration of a core LSV and that have different sustainability traits. LSVs 100 illustrate the modular or configurable nature of contemplated electric LSVs that may be adapted after manufacturing or even at or during a point-of-use. Acceptable LSVs include the Aryo Inc., Club Car™ LSV (see URL ayro.com).

LSVs 100 are presented as a foundation for discussing traits at a high level. Traits are considered measurable features or attributes of the vehicle and may cover a broad spectrum of sustainability aspects. As illustrated, traits may be quite varied and may be characterized by a type of trait (e.g., an attribute, a feature, a component, etc.) and a value for the corresponding trait (e.g., attribute-value pair, etc.). Still, one should appreciate that a vehicle could have more than one trait of the same attribute (e.g., color::black, color::white, etc.) where each trait could have different values that are valid at a given time.

Consider flatbed LSV 100A. Flatbed LSV 100A has several sustainability traits that may be quite useful at a point-of-use. Further, LSV 100A may have several traits that are common to other configurations as illustrated. In this case, common traits may include trait 115, which may comprise an attribute-value pair of “visual::white” or include trait 135 which has an attribute-value pair of “dimensions::[155 in, 60 in, 76 in]” where both trait 115 and trait 135 may be shared by other configurations of the vehicle. One should appreciate trait 135 also illustrates that an attribute y have a multi-valued value. Trait 110A has an attribute-value pair of “weight::low” which could be specific to LSV 100A. Further trait 110A also illustrates the value of the attribute-value pair could be a subjectively measured value in addition to have an empirically measured value such as weight measured in pounds, tons, kilograms, or other weight unit. With respect to sustainability, flatbed LSV 100A may fit in a sustainability environment where low weight is required to reduce impact on local terrain (e.g., golf course, beach, etc.).

Now consider pickup LSV 100B. LSV 100B may share some traits with LSV 100A. However, it may have other shared traits that are not necessarily part of LSV 100A. For example, trait 125B indicates LSV 100B has an attribute-value pair of “fluids::brake” indicating LSV 100B uses brake fluid, which could be considered toxic to the environment or not sustainable. Such a trait may or may not be common among other configurations. Perhaps LSV 100A may use air brakes or electromagnetic brakes rather than hydraulic brakes. Thus, the type of fluid use or type of brakes may be more sustainable (e.g., air brakes, electromagnetic braking, etc.) relative to other types of brakes and may be much less toxic to the environment.

Continuing with the example of LSV 100B, another trait may include a center-of-mass trait as indicated by trait 140. Trait 140 comprises the attribute-value pair of “Com::low” indicating the center-of-mass is low on the vehicle, which provides for preventing the vehicle from rolling over on steep slopes and could be considered more sustainable. Further, LSV 100B may have a different weight trait from LSV 100A as represented by trait 110B. Trait 110B indicates LSV 100B is of medium weight. Medium weight may be less sustainable than the low weight of LSV 100A, but would be acceptable from a utility perspective depending how or where the vehicle is to be deployed. For example, medium weight LSV 100B may be considered sustainable in a campus or apartment complex environment where terrain is more forgiving from a sustainability perspective rather than a natural environment (e.g., forest, park, golf course, etc.). While the center-of-mass value is represented as “low,” one should appreciate that such traits may also take on actual values (e.g., an (x, y, z) coordinate of center-of-mass, a relative position of the center-of-mass, etc.).

Yet another possible configuration is represented by van-box LSV 100C. In this example, LSV 100C also shares a number of traits with the other example LSVs (e.g., color, dimensions, etc.). However, the van-box configuration may also have traits that are configuration-specific. As illustrated van-box LSV 100C has a weight trait of “heavy” indicating it may be less sustainable due to weight than the other configurations. More specifically, it would likely not be sustainable to use such a heavy configuration on a golf course; however, the heavy configuration would likely be sustainable when used on more robust terrains such as pavement or rock. Still further, LSV 100C includes a different fluid trait; trait 125C indicating the vehicle uses R22 refrigerant fluid, which could be less desirable from a sustainability perspective. Another configuration-specific trait may include trait 120 indicating the rear of the vehicle is opaque. Such a visual trait may be less desirable when it is important to have a reduced visual impact so that view of scenery remains unobstructed as the vehicle passes through its operating environment. Yet another trait could include trait 145 comprising a tilt angle (i.e., the angle of tilt where the vehicle will tip over). In this case the tilt angle may be about 50 degrees, which may be less than the tilt angle of LSV 100A or 100B. Thus, a low tilt angle may be less useful for hilly terrain, but acceptable for relatively flat for controlled terrain.

The discussion relating to FIG. 1 is intended to convey multiple concepts relating to sustainability traits. First, traits may be common among various vehicular configurations at a point-of-use. Second, traits may be specific to a configuration at a point-of-use or could even be adjusted during use, possibly based on context. For example, the flatbed of LSV 100A could be swapped out for the van box of LSV 100C as the need arises due to the modular nature of the LSVs presented in FIG. 1. Third, sustainability traits do not necessarily have to be defined just at a point-of-design or manufacture but could be altered throughout the lifetime of the vehicle as juxtaposed against utility of the vehicle. Fourth, there may be many different dimensions of sustainability, which may be quantified. Example types of traits which may be considered dimensions of sustainability, include physical traits, visual traits, auditory traits, functional traits, thermal traits, electromagnetic traits, emissions traits, wake traits, toxicity traits, or other traits that could impact sustainability of LSVs 100. Each of these types of traits may represent a dimension in the sustainability space.

In view there may be a large number of sustainability dimensions, it may be quite difficult to manage corresponding data. Multiple approaches could be leveraged to bring the sustainability space into manageability. For example, in some embodiments, the sustainability trait space may be defined according to a well-defined sustainability namespace. Such an approach is advantageous because it provides for creating a standardized sustainability certification process by which many manufactures, vendors, operators, or other stakeholders may interoperate in a trusted marketplace. Such a namespace may be broken down into attribute types, sub types, or other hierarchies as desired. Such a data space may be organized according to a Management Information Base (MIB) structure similar to what is used for the Simple Network Management Protocol (SNMP). Consider the trait dimension “visual.” Rather than treating the this dimension as a high level concept, it could be further broken down into sub categories such as “visual.color” to represent one or more values for colors used on the vehicle or “visual.aesthetic” to represent a consensus of how pleasing people find the vehicle, perhaps one a scale of 1 (ugly) to 10 (stunningly beautiful). Further, the dimensions may be further detailed perhaps including “visual.color.R,” “visual.color.G,” or “visual.color.B” to represent the RGB values of the paint used for the vehicle. Thus, the sustainability namespace may comprise any practical number of dimensions, where each dimension may have any practical number of sub dimensions. Each value corresponding to the traits may be quantified as practical, possibly with a single value or with multiple values as required by the nature of the trait type corresponding to the dimension.

Alternatively to, or in addition to namespaces, the sustainability trait space may be quantified according to an ontology where the sustainability of a vehicle is categorized by object, kind, mode, attributes or other categories. An advantage of using a well-defined ontology is that an ontology provides for establishing relationships among the ontology dimensions where a first dimensional value may be related to another dimensional value.

To reiterate, the values of a trait may be empirically measurable via sensors or other devices or may be assigned subjective values. In principle any type of value (e.g., number, text, currency, etc.) may be used. Still, the measured values give rise to the ability to determine a degree to which the corresponding vehicle satisfies a set of sustainability criteria at any point in the vehicle's lifetime. Thus, the sustainability trait space may be considered to cooperate with the rules or requirements used to create sustainability criteria.

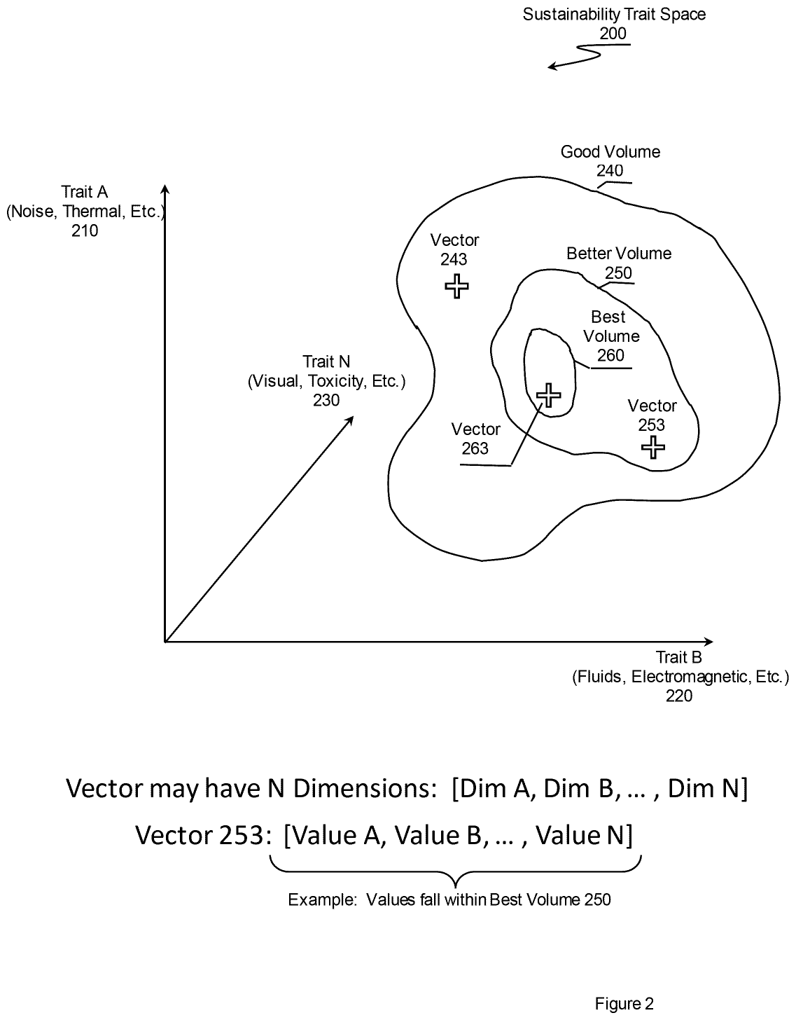

FIG. 2 provides an overview of a sustainability trait space relative to desirable sustainability criteria. In the example shown, sustainability trait space 200 comprise multiple dimensions according to trait type as represented by Trait A 210, Trait B 220, through Trait N 230 thereby indicating trait space 200 may have any practical number of dimensions, even though only three are shown. Each trait type preferably represents its own dimension. Still, some dimensions may be correlated with other dimensions (e.g., weight and size, etc.).

Sustainability criteria may be considered as a defined volume or space in sustainability trait space 200. For example, the sustainability criteria could represent a spectrum, which gives rise to a possible set of satisfaction levels that could be considered as satisfying the criteria. In the example shown, there are three levels: “good,” “better,” “best.” Still, one should appreciate the corresponding satisfaction level of a sustainability criteria set may take on different forms including a single valued metric, possibly normalized (e.g., 0 to 1, 0 to 10, 1 to 100, etc.), or even multiple values (e.g., average value with statistical spread, etc.). Good volume 240 represents a volume in trait space 200 having a collection of points that would be considered to be good enough with respect to satisfying sustainability criteria. More specifically, vector 243 represents a point in the space where trait values forming the point fall in the good enough volume 240.

Better volume 250 as illustrated has more stringent requirements for satisfaction. Thus, in order for a vehicle to have a better satisfaction level, it should have corresponding trait values that fall within the volume or space as indicated by vector 253. To be clear, the vector 253 may be represented as a vector data structure in a computer readable memory where each member of the vector represents a dimension and has a specific value as illustrated. However, it should be appreciated that other data structures are also possible including Ntuple having a collection of attribute-value pairs. In some scenarios, the Ntuple may only include pairs having relevance to the vehicle, rather than including a complete collection of pairs spanning the entire namespace or ontology. The data structure could also be a table listing the value, which could also include NULL values. Thus, one should appreciate the term vector is used euphemistically to represent a data structure having values represented in the sustainability trait space 200.

Best volume 260 further tightens the constraints on sustainability by restricting the volume even further. Thus, vector 263 may be considered as having sustainability values representing a high sustainable vehicle. While only one best vector 263 is presented, there may be multiple vectors having values that fall within the target volume or space.

Sustainability trait space 200 is illustrated, more or less, as a static, well-defined space. However, as the understanding of sustainability grows, sustainability trait space 200 may grow as well to reflect the new understanding. Therefore, sustainability trait space 200 may grow by adding new dimensions or adding new sub dimensions along with corresponding acceptable values. It is also possible that dimensions or acceptable values may be removed from sustainability trait space 200, perhaps in response to learning a specific paint may be toxic for example. In such cases, a vector may suddenly fall outside it's target updated satisfaction level. For example, better volume 250 may shift shape or size causing vector 253 to fall from “better” to “good” or even to suddenly become unacceptable. Thus, the inventive subject matter is considered to include management of sustainability trait space 200 as a dynamic data construct that may change based on time, based on changing conditions of a vehicle, based on context, or other factors.

Of further note, vehicles are dynamic objects that may change in real time. This means the sustainability of the vehicle may also change with time. For example, at a point of manufacture a vehicle may be represented by sustainability vector 263. However, during use or over the course of time, the vehicle's sustainability vector could be updated with new values causing it to move beyond a desired satisfaction level. In which case, an alert may be generated to notify interested parties or stakeholders (e.g., operator, owner, manufacturer, etc.). It should be appreciated that the nature of sustainability trait space 200, sustainability criteria, or sustainability vectors could all change in time individually or collectively.

The sustainability vector may be processed by one or more sustainability criteria sets. Each sustainability criteria may comprise conditions, requirements, rules, or other features that yield a resulting satisfaction level. In the examples shown in FIG. 2, the satisfaction level is simply good, better, or best. However, the satisfaction level may be quantized in other ways as well. In some embodiments, the satisfaction level could be characterized by a Euclidean distance between a point defined by the measured values of the sustainability vector and one or more points in the acceptable volume or space. In other embodiments, the satisfaction level could be quantified based on a Hamming distance which indicates how many of the individual criterion are satisfied.

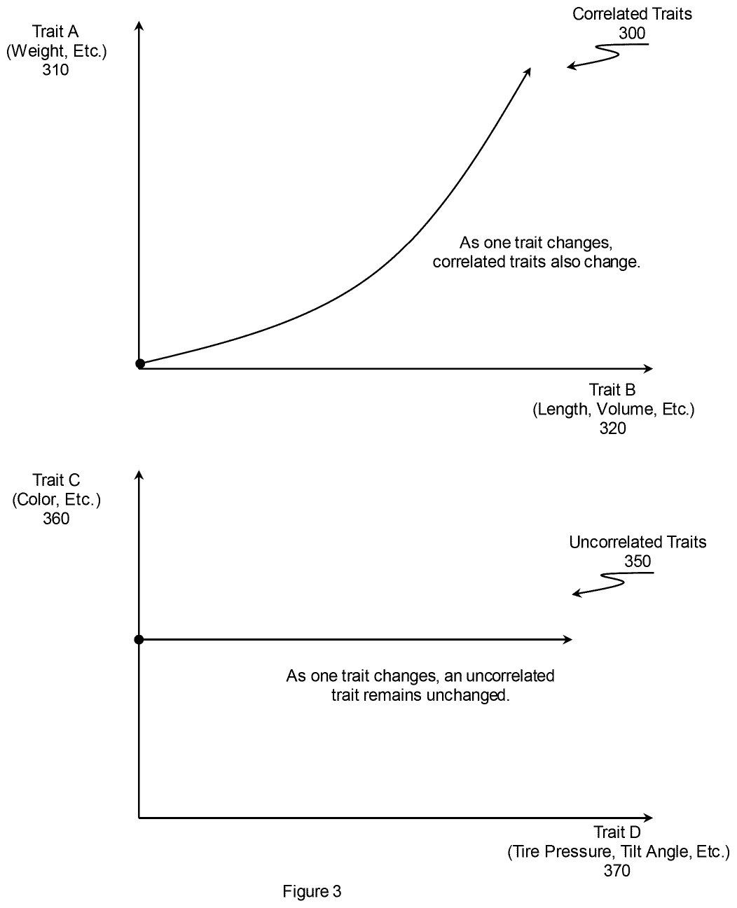

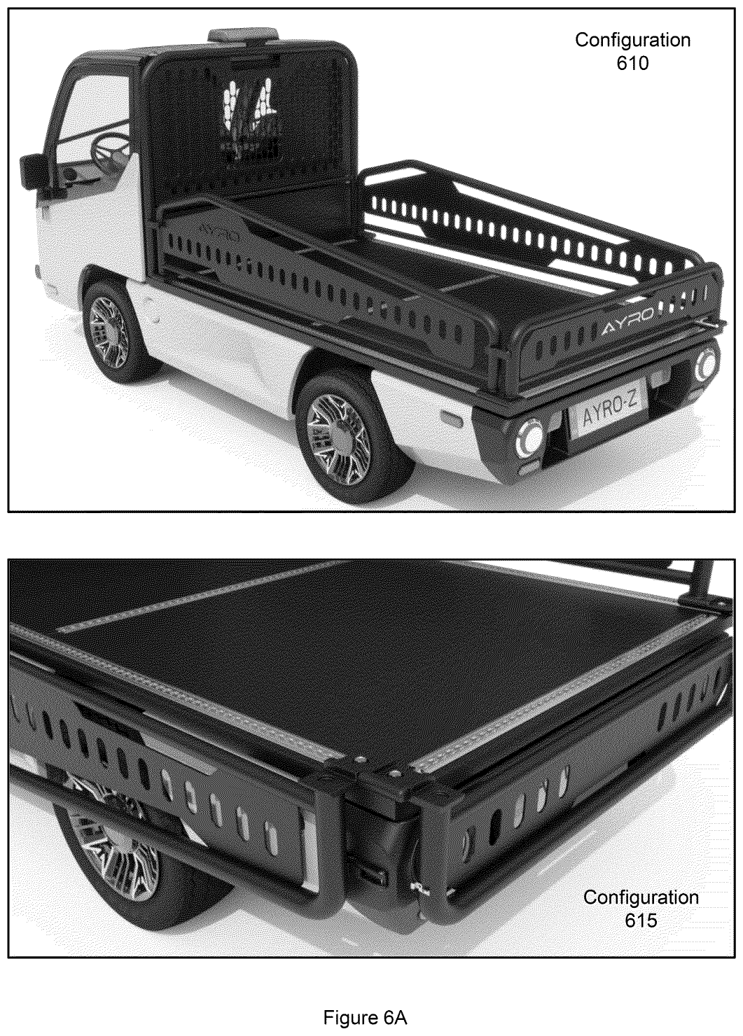

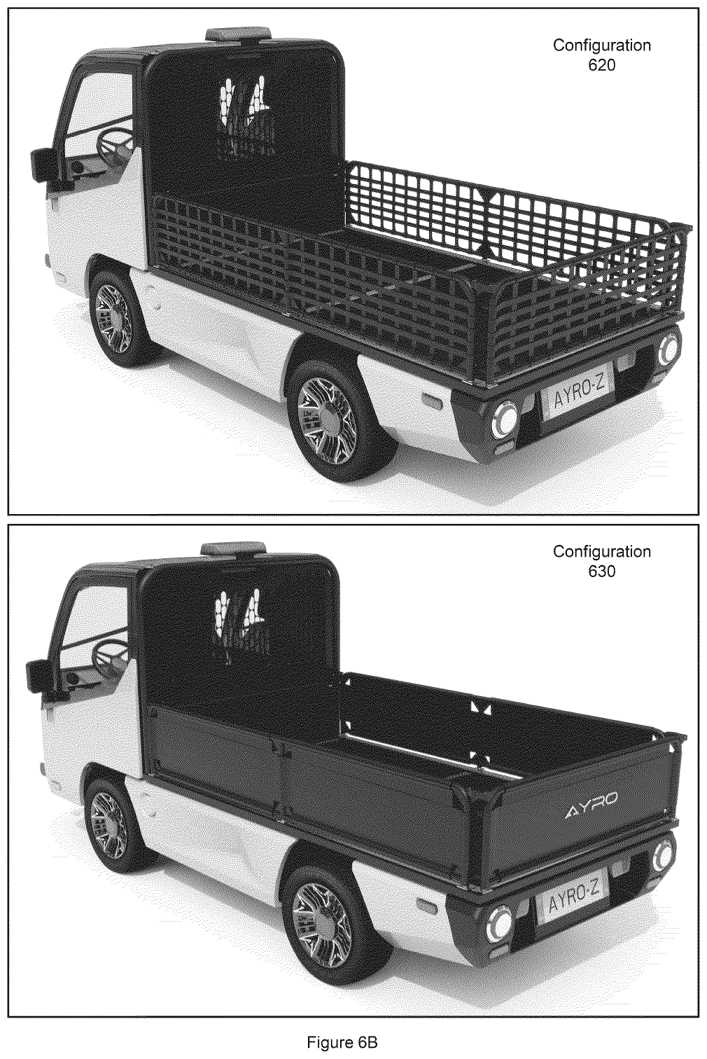

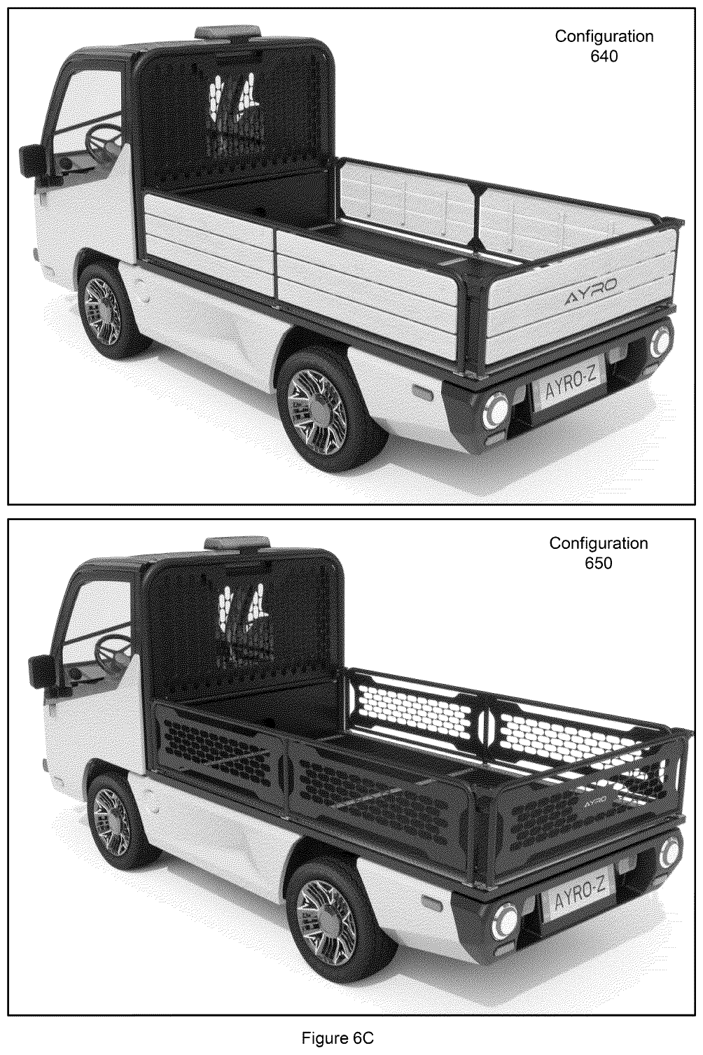

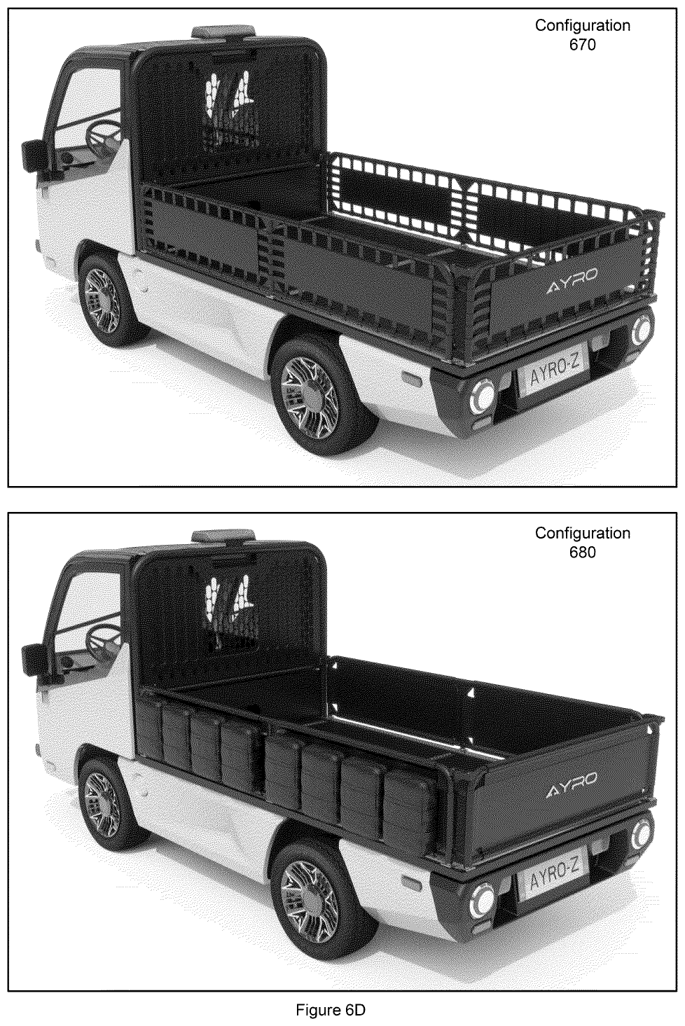

FIG. 3 provides some additional details regarding the nature of a sustainability trait space. Not all trait dimensions may be treated as independent or orthogonal to all other trait dimensions. For example, the top graph illustrates how correlated traits 300 may behave relative to one another. Correlated traits 300 include trait A 320, say weight of an LSV, and trait B 320, say a length of the LSV. In this example, if the size (e.g., length, width, height, etc.) of the LSV increases, the weight would also increase assuming construction material remain the same. Still, it is possible to change construction materials to compensate for changing a value in one of the correlated traits 300. Perhaps bamboo is used to replace steel or aluminum as a construction material in some parts of the LSV (see FIGS. 6A through 6D). Therefore, the trait space used to define sustainability may be constructed to account for or compensate for correlated traits 300 by including one or more rules or relationships among trait dimensions. Such correlated traits give rise to the ability to validate sustainability during use or in the field. For example, if a bad actor wishes to cheat the system by changing an easily observable trait to a more favorable value, then a correlated trait may be measured to ensure it changes as expected. If not, then the sustainability cannot be validated.

The bottom graph illustrates uncorrelated traits 350. As one trait changes, trait D 370 for example, another trait does not change, trait C 360. Consider changing a tire pressure trait of the LSV. Any change of tire pressure does not affect the color of the vehicle. While this may seem a trivial example, it is presented to clarify that traits may be truly orthogonal relative to each other, while also being coupled to yet other traits. Returning to the tire pressure example, clearly tire pressure does not affect color. However, tire pressure could impact an amount of carbon black residue left behind during LSV use, especially depending on the area of use (e.g., road, pavement, grass, natural terrain, etc.). In such a scenario, the disclosed techniques may include notifying a stakeholder that a tire containing carbon black may need to be replaced with a different tire comprising more sustainable material, possibly graphene for example.

The discussion related to FIGS. 2 and 3 should clarify that a physical vehicle may be characterized by a sustainability vector which may or may not satisfy sustainability criteria, which may be contextually determined. Thus, the vehicle's sustainability satisfaction level may be quantified and stored in computer memory, which may trigger various actions (e.g., updates, maintenance, alerts, etc.). Still, there is a need for managing the sustainability of a vehicle throughout its full lifetime.

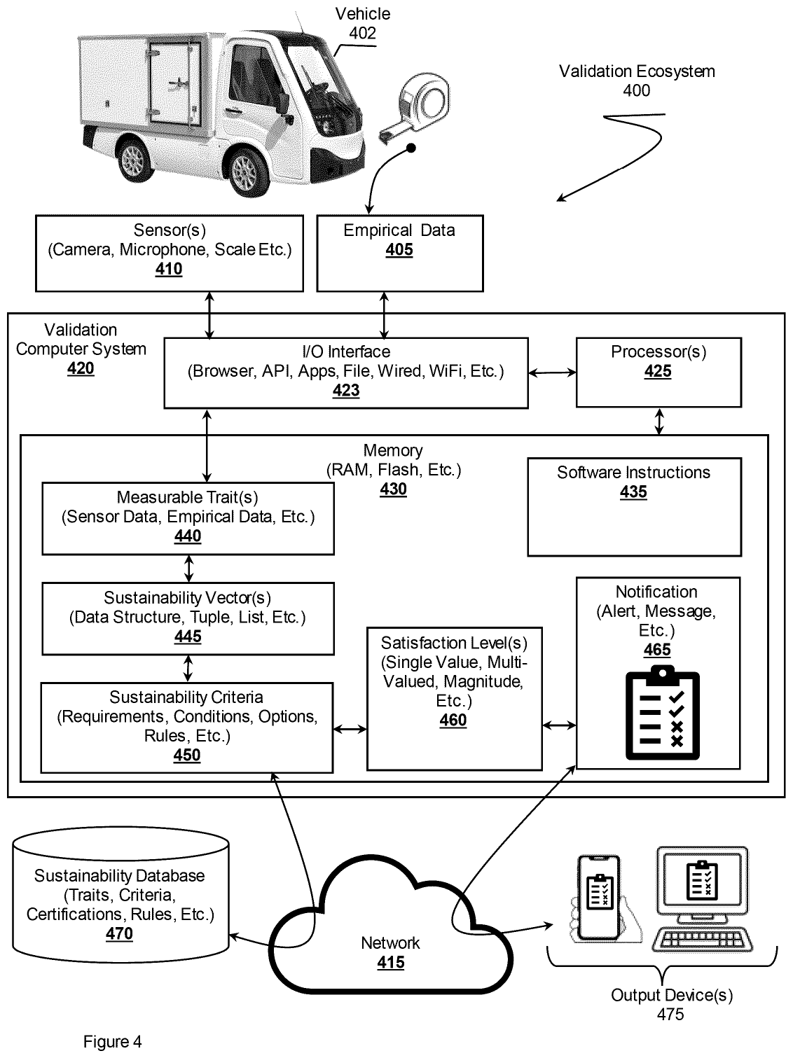

FIG. 4 provides an overview of sustainability validation ecosystem 400 that provides for computer-based management of vehicle sustainability over the full lifetime of an LSV, vehicle 402 for example. Validation ecosystem 400 includes one or more of validation computer system 420 that determines a sustainability satisfaction level 460 of vehicle 402. Validation computer system comprises one or more of computer readable memory 430 and one or more of processors 425. Memory 430 stores one or more sets of software instruction 435 according to which processor 425 execute the disclosed roles or responsibilities. While illustrated as a single computer device, it should be appreciated that validation computer system 420 could operate on one or more devices possibly including mobile phone, tablets, servers, instances on cloud computing systems (e.g., AWS, Azure, Google Cloud, etc.) individually or collectively.

Consider vehicle 402 with respect to validating sustainability. Vehicle 402 may have its sustainability quantified in different ways. In some embodiments, one or more of sensors 410 may be leveraged to collect sustainability data of the vehicle. Different types of sensors 410 typically align with a corresponding dimension in the sustainability trait space. For example, a scale sensor would align with a weight trait, a camera sensor would align with a visual trait, a microphone sensor would align with a noise or auditory trait, and so on. Sensor 410 may be directly or indirectly connected with validation computer system 420 as necessitated by use scenarios. While in some embodiments sensors 410 may be deployed in a testing facility, one should appreciate that sensor 410 may be disposed in LSV 402 or about the operating environment of LSV 402. Thus, sensors 410 may provide a real-time (or near real-time) sustainability sensor data stream.

Sustainability trait values may also be measured empirically as indicated by empirical data 405. In this case, a person or other entity may be instructed to physically measure the traits of the vehicle, perhaps using a tape measure or a thermometer, and then provide the empirical data 405 to the validation computer system 420 via a user interface.

Regardless of the source of sustainability data (e.g., sensor data, empirical data, ambient data, etc.), the data may be provided to validation computer system 420 via one or more of I/O interface 423. Thus, sensor 410 may provide sensor data via a direct connection, wired connection, over a network, via an API, or other electronic interface. Further, empirical data 405 may be captured via an interactive user interface: a browser, file system, audio capture, or other type of interface 423 amenable to a user. As the data enters validation computer system 420, the sustainability digital data is stored in memory 430. The sustainability data may require some preprocessing depending on the nature of the raw data itself (e.g., raw sensor data converted to actual values, etc.). For example, sensor data may require conversion from a raw sensor value to a desired digital value; say converting a sensor value of 0 to 255 to a weight, temperature, pressure, force, or other type of data. With respect to empirical data, text may be entered into a user interface and the sustainability validation system 420 may convert the text to numerical or other digital values as necessary. Once any require preprocessing is complete according to software instruction 435 the data may be considered as representing one or more of measurable trait 440, preferably having values that are acceptable to the sustainability trait space or adhere to the standard for the trait space. While a single set of measurable traits 440 are illustrated, one should keep in mind that more than one sustainability validation may be occurring at the same time based on operation of software instruction 435, especially based on a given context (e.g., use, location, operator, etc.). Thus, as a vehicle's context is changing, one or more sustainability criteria may become active or inactive.

Measured values corresponding to measurable traits 440 may then be packaged as one or more sustainability vector 445. There is no requirement that every measurable trait 440 be placed into sustainability vector 445 as circumstances or context may dictate which traits are of most relevance according to the sustainability logic encoded into software instruction 435. This approach is advantageous because sustainability vector 445 will have a smaller memory footprint and will consume less bandwidth when the vector is transmitted over a network. Further, software instruction 435 encode rules by which sustainability vector 445 is constructed. As discussed above, sustainability vector 445 may be encoded as a data structure, a vector, an Ntuple, a list, a table, a JSON file, an XML file, or other digital data format that may be processed by processor 425.

Sustainability vector 445 may be compared against one or more of sustainability criteria 450 to determine a corresponding satisfaction level 460 of vehicle 402. The sustainability criteria 450 may include one or more sustainability criterion representing requirements associated with one or more dimensions of the sustainability trait space. Thus, the criteria may operate based on absolute requirements, relative requirements, optional conditions, sustainability rules, or other factors. Such criteria may be represented as Boolean logic, measured values, or other types of rules. Further, the criteria may be context-specific and encoded in various ways, including JSON, XML, YAML or other coding schemes. This approach is advantageous because as the vehicle's context changes, the active sustainability criteria may be swapped out or switched in real time. For example, and LSV operating in a forest may have different active criteria than when the same LSV is operating on a neighborhood street. Even further, multiple sustainability criteria may be active at the same time depending on the context of the LSV.

One result of running sustainability vector 445 through sustainability criteria 450 is a quantified result of one or more of satisfaction level 460, which quantifies how well the vehicle adheres to sustainability requirements. As referenced previously satisfaction level 460 may take on a broad spectrum of values. In some embodiments, the satisfaction level 460 could be a binary representation: acceptable or unacceptable (or variations thereof). However, satisfaction level 460 preferably has more nuanced values possibly including a single metric representing the sustainability of the vehicle. A single metric could be calculated as a Euclidian distance from the vector in trait space to the most desirable location in trait space, where small distances would be considered better. Also, as mentioned previously, satisfaction level 460 could be represented as a Hamming distance, which may include a count of which traits do or do not adhere to the desirable criteria. Such calculations of satisfaction level 460 may also leverage weighted factors according to various dimensions. Some dimensions may be more important than others especially from a utility perspective. For example, while the color of a LSV may be considered disruptive, the color trait values may be down weighted relative to the LSV's weight when operating in a forest environment. However, the opposite may be true (e.g., color is up weighted) if the same LSV is operating in an urban setting where many people may observe the LSV. The weighting factors of each dimension or each dimension's corresponding trait values may be encoded in rules in software instructions 435 or more preferably encoded in sustainability criteria 450.

Satisfaction level 460 may also be a multi-valued metric indicating to what degree the sustainability vector 445 adheres to sustainability criteria 450. In some embodiments, the satisfaction level 460 may include a normalized average across all relevant dimensions thereby yielding an average along with additional statistical values; median, mode, standard deviation, or other higher modes. Yet in other embodiments, satisfaction level 460 could comprise a visual representation illustrating how each salient dimension of interest satisfied the sustainability criteria 450. In such cases, the visual representation could be in the form of a spider plot, graph, table, chart, heat map, or other suitable form.

Recall that a sustainability of a vehicle may change in real-time or otherwise be dynamic throughout the lifetime of the vehicle. Thus, one or more of the contextually relevant sustainability vectors 445 may also change with time as discussed previously. Of particular note a satisfaction level 460 may also be coupled with information relating to suggested or proposed changes to sustainability vector 445 where the suggested or proposed changes would bring the sustainability vector 445 into better alignment with the sustainability criteria 450. Thus, such suggested or proposed changes to sustainability vector 445 could include a degree of difference between a current sustainability vector 445 and a desired configuration given a new context or a soon to be active context.

Consider a scenario where an LSV is transitioning from an urban or campus context to a forest context. Initially the LSV may have a sustainability vector 445 that satisfies sustainability criteria 450 for the urban or campus context. As an operator continues to operate the vehicle, then the vehicle may report how well the vehicle is adhering to the urban context's sustainability criteria 450 while also offering suggestions or recommendations to gain better sustainability. In this case, tire pressure may be high to increase performance efficiency on paved roads and the color of the vehicle may be kept neutral for the setting assuming the vehicle is able to display desired colors via LED surfaces. However, as the LSV transitions to the forest setting, the LSV's sustainability vector 445 may fail to satisfy sustainability criteria 450 of the forest context which becomes active. In which case, the LSV may present configuration options to the operator or take action automatically by decreasing tire pressure to reduce the weight per unit area on the terrain, change the color of the LSV to better blend in, and possibly enforce a slower speed to reduce noise, which may not be relevant to the urban context. Thus, the inventive subject matter is considered to include automatically sensing a sustainability context and automatically adjusting the performance characteristics of the vehicle to better align the vehicle's sustainability vector 445 with a new context.

One example of a vehicle taking automated action could include noise abatement. While the current discussion is with respect to quiet electric LSVs, such LSVs still generate some noise. For example, brakes may squeal, or music may be playing on the radio. In some embodiments, as the LSV shifts from a context that includes a noise-tolerant area, say a road, to a noise sensitive area, say a nature park, validation computer system 420 may sense the shift in context. In response, possibly via notification 465, the validation computer system 420 may cause the LSV to change its performance characteristics with respect to noise; the radio could have its volume turned down or the radio could be turned off, for example. Further, with respect to vehicular noise in general, one or more active noise canceling or noise reducing devices may be activated, possibly operating as a phased acoustic array.

As illustrated in FIG. 4, the satisfaction level 460, along with other related information, may be packaged in notification 465 and transmitted to one or more output device 457 possibly over network 415. Notification 465 may take on different forms depending on a desired action to be taken. In some embodiments, notification 465 may comprise a simple digital message (e.g., SMS, email, voice mail, web post, database submission, etc.) indicating the nature of satisfaction level 460. Still, as alluded to above, notification 465 could be more complex and include alerts, recommended changes to the LSVs configuration, calls to an API or a remote procedure call, submission to sustainability database 470, or other types of digital communications or interactions. Notification 465 may also be packaged as desired and should remain compatible with local sustainability agents or clients installed on output device 475 (e.g., phone, computer, the vehicle itself, etc.). Typically, notification 465 may be package according to a serialized format possibly including XML, JSON, YAML, or other encoding schemes. Further, as circumstances dictate (e.g., military use cases, government use cases, etc.), notification 465 may be encrypted according to one or more cipher algorithms (e.g., blowfish, AES, 3DES, etc.).

One or more of sustainability database 470 may also be part of validation ecosystem 400 and provide various additional capabilities. As suggested above, sustainability database 470 may be used to archive one or more of notifications 465 and corresponding information (e.g., satisfaction criteria 450, sustainability vector 445, satisfaction level 460, etc.). Archives of such information are considered advantageous for audit purposes, say for government or military use cases where sustainability adherence is a matter of law or a matter for insurance. Further, sustainability database 470 may also be used for more proactive purposes. For example, sustainability database 470 may operate as service providing valid trait space definitions, sustainability criteria, requirements for certifications, rules governing how validation computer system 420 should operate, versions of software instruction 435, or for providing other information.

As an example, consider how state-run DMVs operate smog test centers. When a person has their vehicle tested, the results are submitted to the DMV database. In the context of the present disclosure, such smog testing facilities could be extended to provide certification services with respect to sustainability by archiving test results into sustainability database 470.

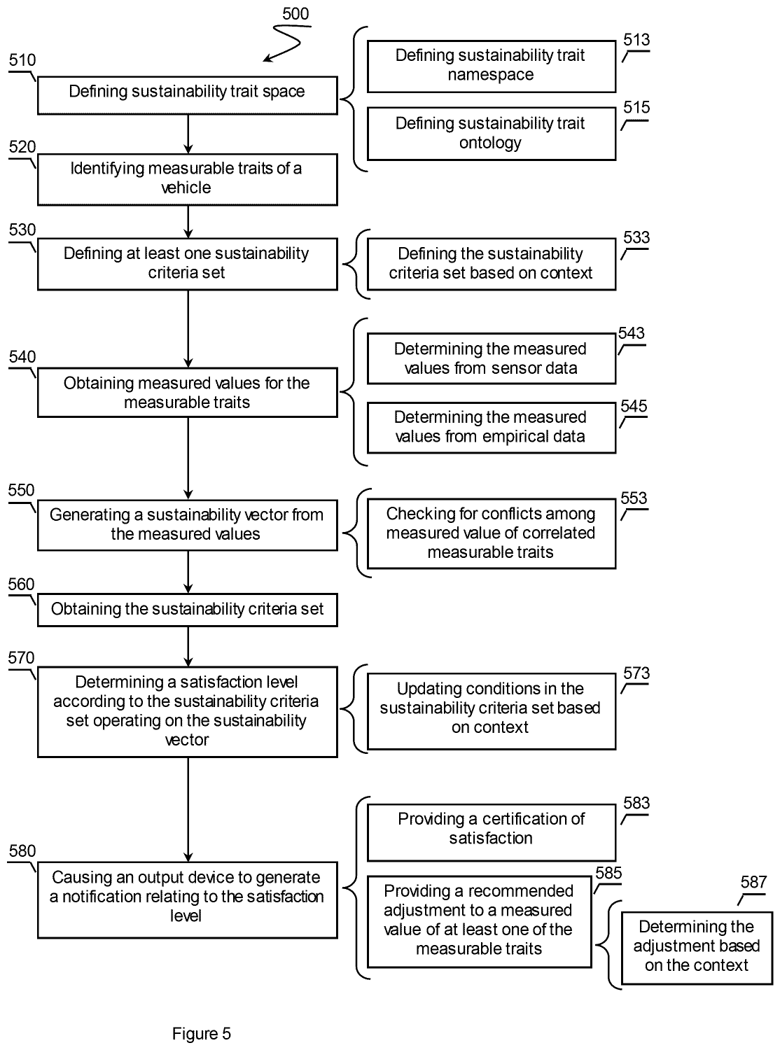

FIG. 5 presents an overview of computer-based method 500 of validating a sustainability of a vehicle. From a general point of view, method 500 may begin at step 510, which includes defining a sustainability trait space. In more preferred embodiments, the sustainability trait space comprises a multi-dimensional space where each dimension represents a type of sustainability trait that may be quantified. Further, the trait space may be measured according to the trait modality. Some modalities, such as weight or physical volume of a LSV, may be easily represented as a number or other value that ranges from a low value, say zero albeit un-realistic for some modalities, to a high value. For example, weight may range from a low practical value of 100 Kg to a high practical value of say 2000 Kgs, or even higher depending on the nature of the vehicle. Other modalities may be less amenable to being placed on an easy to represent scale using just numbers. However, these modalities may be mapped to a spectrum. For example, subjective sustainability traits such as aesthetics could be mapped to a value of 1 to 5, or 1 to 10, or other acceptable ranges based on survey data obtained from interested third parties. Still, one should appreciate that such trait modalities could be context specific. Said differently, the aesthetics of an LSV may be acceptable for one setting, a golf course for example, relative to a completely different setting, hospital campus for example. Thus, the trait scales or ranges may be context or domain-specific and defined as practical.

In some embodiments, as discussed previously, method 500 may further include defining the sustainability trait space as a namespace as suggested by step 513. In such embodiments, the sustainability trait namespace is well-defined as a sustainability standard or according to a sustainability standard thereby giving rise to a sustainability certification ecosystem. Such namespaces may be extensible so that as new sustainability information becomes available the namespace may add or subtract dimensions of relevance. Further, the sustainability namespace data construct or object may comprise metadata including a version number (e.g., rev number, certification number, time stamp, etc.) or other metadata so that LSVs may be configured to adhere to current standards as the namespaces evolve. Contemplated namespaces may be hierarchical in nature, possibly as a Management Information Base (MIB), which gives rise to alerting capabilities via networking protocols such as Simple Network Management Protocols (SNMP). Thus, the sustainability namespace may include hierarchical attributes which may couple with one or more corresponding measured trait values.

In addition to or alternatively to, method 500 may also include defining the sustainability trait space as an ontology as suggested by step 515. A sustainability ontology may comprise some advantageous features by including relationships among the sustainability dimensions. Thus, correlated traits may have their relationship encoded in the ontology (e.g., weight and size, fluid and toxicity, etc.). While ontologies may be more complex to manage than a namespace, they are thought to provide more functionality. However, such functionality may come at the cost of computer memory and may not be suitable for on-board LSV embedded systems.

One should appreciate, as alluded to above, that a namespace or ontology may be encoded in a digital construct or class object. Thus, the corresponding class object may include supporting member functions that permit management of the LSVs sustainability ensuring the sustainability vectors, measured trait values, or other features adhere to the standardized formats.

Somewhat related to step 510, step 520 includes identifying measurable traits of a vehicle. In scenarios where the sustainability trait space is not necessarily well-defined, step 520 could be nearly identical to step 510 because defining the measurable traits of the vehicle would include defining which traits make up the sustainability trait space, possibly specifically for the target vehicle or model, or for a specific context or domain. However, in other embodiments that leverage the sustainability trait space for standards compliance or certification, step 520 may represent selecting which traits from the sustainability trait space are most relevant for the vehicle. Consider as an example a use case where the sustainability trait space includes two different dimensions including a Li-Ion battery charge dimension as well as a green-house gas emission dimension. While these two dimensions may not necessarily be mutually exclusive (i.e., in a hybrid vehicle), they may not be relevant for all vehicles. Thus, selecting a measurable trait (e.g., a dimension of relevance, etc.) for an all-electric LSV would likely require selecting the Li-Ion battery level trait, but not selecting a green-house gas emission trait. Further, selecting measurable traits for a gas driven vehicle would likely include selecting the green-house gas emission trait, but not the Li-Ion charge trait. Therefore, the inventive subject matter is considered to include electing or not electing traits, possibly automatically or from dashboard tools, from the dimensions of the sustainability trait space, especially well-defined or standardized sustainability trait spaces.

As reference above, the sustainability of a vehicle could be context or domain specific, or even depend on the nature of the vehicle throughout its lifetime. Therefore, step 520 may further include compiling the measurable trait of the vehicle for each specific context along with the defining characteristic of the context itself. For example, a context may be considered a set of measurable conditions that represent a specific circumstance in which the vehicle exists, possibly at a moment in time. Example measurable conditions may include a specific absolute time or date (e.g., time of manufacture, time of use, data of use, etc.), a relative time or date from a specific time or date, duration of use, a geographic location, a relative location, a target use case, a vehicular operator identifier, vehicle history (e.g., charge level, wear level, age, etc.), or other measurable information related to the vehicle. Identified measurable traits and/or context information may feed into step 530 or archived for audit purposes.

Step 530 may include defining at least one sustainability criteria set. While the sustainability criteria set could comprise a single criterion, more preferably the sustainability criteria set may be quite complex and include multiple, individual sustainability criteria where each criteria includes one or more criterion. Further the criteria may comprise required features, optional features, define circumstances or applicability, or other information to quantify whether a vehicle satisfies its target sustainability or not, possibly at any moment in time. Additionally, as suggested above with respect to step 520, the sustainability criteria set may also include rules defining corresponding context to which each individual criteria applies as suggested by step 533. Thus, during the use of the vehicle, or other point in the vehicle's lifetime, contexts may change as position, location, time, or other factors change, which in turn may cause an individual sustainability to become active or inactive. In such cases, the sustainability criteria may include rules (e.g., routines, software, functions, Boolean logic, etc.) that govern the behavior of the sustainability criteria as a function of context attributes. From a practical standpoint, as contexts change the corresponding computer validation system may instantiate a sustainability tracking object in the memory of the computer where the sustainability tracking object monitors contexts and includes context specific sustainability criteria.

At step 540, method 500 includes obtaining one or more measured value for the measurable traits. As discussed previously, obtaining the measure values may be performed at any point in time during a vehicle's lifetime including at the time of design, time of manufacture, time of use, time of disposal, time of storage, or other times. Further, in some embodiments, obtaining the measured values may be done in real-time or continuously, especially in various times of use or within specific contexts as circumstances dictate. Depending on the circumstances or choices made in the implementation of the disclosed subject matter, the measured values of the identified measurable traits may be obtained in different ways. In some cases, the measurable values may be obtained directly or indirectly from one or more sensors via corresponding sensor data as indicated by step 543. For example, one or more sensors may be coupled directly with the validation computer system, which in turn reads the sensor data directly from the sensor. However, one or more sensors may be remote from the validation computer system, in which case the validation computer system may be required to query remote devices or the remote sensors to obtain the sensor data. Such an approach is likely a web-based or a cloud-based ecosystem supporting sustainability testing for certification purposes, say at a DMV or maintenance center. Still, the measured values may also be obtained by determining values from empirical data that may be inputted into the validation computer system as indicated by step 545. In such cases, an entity (e.g., robot, human, etc.) may take a physical measurement of some form and then input the data into the validation computer system via one or more user interface (e.g., a browser, application, API, RPC, spreadsheet, etc.). From an implementation perspective, the measured values may be stored in a computer readable memory according to the definition of the sustainability trait space (e.g., floating point number, integer, text, video, image, etc.). More specifically, the sustainability trait space may include one or more class objects representing measurable traits and their corresponding measured values and that may be instantiated in the memory of the computer system.

Turning toward step 550, the method may also include generating a sustainability vector from the measured values. This step may include converting the sensor data or empirical data into suitable values for incorporation into the vector data structure. For example, some sensor data (e.g., piezoelectric sensors, etc.) simply include sensor values from 0 to a max value (e.g., 255, etc.), which must be converted to appropriate unit (e.g., force, weight, pressure, temperature, etc.). Thus, the validation computer system may consult one or more mapping functions (e.g., algorithms, lookup tables, etc.) to perform such conversions. Further, the measured values may require normalization for proper analysis, possibly scaling to an integer value between 1 and 100 or even a floating-point value between 0.0 and 1.0. Whatever preprocessing may be performed, the generated sustainability vector should properly adhere to the formatting rules required by the sustainability trait space, and more specifically to the operation of the sustainability criteria.

Recall that some sustainability trait dimensions may be correlated with each other. Interestingly, such correlations give rise to enhanced capabilities within the sustainability validation ecosystem. In view that dimensions may be correlated, when the validation computer system observes a change in one trait it should observe a correlated change in another trait. Thus, the validation computer system may take actions including checking for conflicts among measured value of correlated measurable traits as indicate by step 553. As an example, consider one of the previous examples where the vehicle has been designed to be longer or where the vehicle has been configured with additional equipment (see van box LSV 100C configuration of FIG. 1). The weight of the vehicle should also increase. If it does not, the validation computer system may generate an alert indicating a discrepancy thereby giving the system an opportunity to validate if the conflict is valid or invalid. If no other feature of the vehicle has changed (i.e., same construction materials), then something is amiss. However, if additional information is supplied indicating the conflict is acceptable, then the validation computer system may resolve the conflict. In such cases, the validation computer system may provide an interface through which conflict resolution information may be supplied. For example, the system may identify all relevant correlated traits and present them to a user who may then adjust them as needed or necessary to resolve the conflict. From a weight perspective, the construction materials may be changed from steel to bamboo and aluminum, which would resolve the conflict between vehicular size and weight because such manufacturing material are less dense and/or have higher operating strength (see FIG. 6C, configuration 640 and associated discussion).

Step 560 of method 500 includes obtaining a sustainability criteria set. A sustainability criteria set may comprise one or more sustainability criterion as discussed above. One or more sustainability criteria sets may be stored in a sustainability criteria database, possibly local to the computer validation system or remote over a network. A local sustainability criteria database, for example, could be stored in an LSV itself so that as the context of the LSV changes, it may continuously or periodically check on how well it conforms to the context's sustainability. A remote sustainability criteria database may be placed over a network and possibly used as part of a certification processes similar to those used by smog checking stations. Thus, a vehicle may enter a testing station and the station may query the remote database for proper sustainability criteria for the vehicle. Such sustainability criteria may be indexed based on the make of the vehicle, model of the vehicle, VIN number or number range, geographic information, or other factors related to the vehicle or sustainability.

As alluded to above, the sustainability database may store one or more sustainability criteria sets as indexed according to one or more schemas. The index schema may be defined according to a corresponding namespace, ontology, keywords, context attributes, or other factors. From the context perspective, the sustainability criteria sets may be indexed by context attributes possibly including time, location, position, speed of the vehicle, age of the vehicle, relative position, surrounding area attributes (e.g., plains, forest, hills, mountains, water, residential, industrial, etc.), or other context attributes. Therefore, a sustainability criteria set may be obtained based on matching exactly or approximately a context's attributes to those assigned to the sustainability criteria set. One should appreciate the match between a sustainability criteria set does not have to be exact to a context's current attributes. In some embodiments, the match may be performed based on a nearest neighbor query thereby returning one or more sustainability criteria sets, possibly ranked by how closely they match a context's attribute, that are close to the context's attributes.

While the above discussion references a database per se, it should be appreciated that the sustainability criteria sets are not necessarily required to be stored in a formal database (e.g., Oracle®, SQL, MySQL, MongaDB, CouchDB, etc.). Rather the sustainability criteria sets may be indexed via a file system, a lookup table, a hash table, or via other indexing system in a computer readable memory (e.g., flash, RAM, HDD, SSD, etc.).

Once the computer validation system has a sustainability criteria set and a sustainability vector, the satisfaction level may be determined. Step 570 includes determining a satisfaction level according to the sustainability criteria set operating on the sustainability vector. The satisfaction level may be considered a quantification of how well or to what degree the vehicle's sustainability vector satisfies (or doesn't satisfy) a current sustainability. Further, step 570 may be performed as a single operation (e.g., at a testing station, etc.) or over time. For example, the satisfaction level may be measured periodically (e.g., every second, minute, hour, day, etc.), based on triggering conditions (e.g., change in context, time between maintenance, on command by an operator, etc.), or other conditions.

Of particular note, in embodiments where a sustainability context of a vehicle may change, the conditions encoded in sustainability criteria may change according to the context as indicated by step 573. Thus, the corresponding point-in-time sustainability satisfaction level may also be updated or determined again according to rules possibly included with the sustainability criteria.

The sustainability satisfaction level may be used by the computer validation system in many different ways or have many different effects. For example, step 580 includes causing an output device to generate a notification relating to the sustainability satisfaction level. The output device may typically include a computing device including a cell phone, table, dedicated device, web server, computer interface or terminal, the vehicle itself, or other type of device. While such a notification may include a simple text message or other visual indicator representing if the satisfaction level represents a “pass” or “fail,” one should appreciate the notification may be quite complex. More specifically, the notification may be made via an API or RPC call (e.g., RESTful API, internal procedure calls, etc.) which may cause a triggering action by which the output device or the device in the ecosystem may take further action. In some embodiments, the sustainability criteria sets may include one or more instructions by which the notification operates to thereby control or command such output devices.

In embodiments where the sustainability criteria operate according to one or more standards, step 583 may include providing a certification of sustainability in response to the satisfaction level satisfying the sustainability criteria. Such certifications may also be recorded or stored in a remote database for archival purposes or further analysis at a time in the future. One example use of the certification storage is to create a machine learning training data set, which may be used to refine how sustainability may be managed, especially in autonomous vehicles.

Of particular note, beyond merely providing a certification, the notification may trigger additional actions. For example, step 585 may include providing a recommended adjustment to a measured value of at least one of the measurable traits of the vehicle. Recall the sustainability vector comprises one or more measured values for each dimension of the sustainability vector. Thus, the satisfaction level may also include the degree to which the sustainability vector matches one or more corresponding dimensions in the sustainability criteria. The measured values in the sustainability vector may not have values that completely satisfy the sustainability criteria. Therefore, the recommended adjustment may include how much the measured value should be adjusted to ensure the measured value or the sustainability vector better aligns with the sustainability criteria. Such adjustments may be taken automatically by the vehicle itself (e.g., slow down, increase tire pressure, move to a different location, etc.), by the operator of the vehicle, by the designers of the vehicles, by maintenance staff, or other entities in the ecosystem. For example, if an LSV is going to be repurposed from a soft setting (e.g., golf course, etc.) to a more industrial setting (e.g., construction site, etc.), the recommended adjustment could include a recommendation to change tires from a soft tire to a more robust tire and to use a low to no carbon-black tire to reduce impact on the nature of the construction site. More specifically, tires composed of graphene may be used to replace tires composed of carbon black.

Although adjustments to the vehicle may be made to ensure the resulting measured values in the sustainability vectors satisfy the sustainability criteria, there may be scenarios where the adjustment may or may not simply be a one-time static change. Rather, the adjustments may be dynamic in time, based on context for example. Therefore, step 587 may include determining the adjustments based on the context of the vehicle. In such cases, the sustainability criteria may also include rules or instructions by which adjustments may be calculated based on the context, especially when contexts change from one active context to another. As an example, consider where an LSV moves form a forest context to an urban context. A tire pressure adjustment may change from an instruction to lower tire pressure (i.e., in a forest) to an instruction to increase tire pressure (i.e., pavement). Thus, the adjustments themselves may be dynamic in nature and change based on circumstances.

FIGS. 6A through 6D present actual LSV design examples that embody aspects of the inventive subject matter. Although these design examples are presented from the perspective of a pickup configuration of an LSV (see pickup LSV 100B in Figure), the inventive subject matter is not so restricted. Rather the concept behind these design examples may be extrapolated to other features of vehicles including cargo boxes, paint, toxicity, or other trait dimensions. More specifically, the examples presented in FIGS. 6A through 6D illustrate how sustainability traits may be balanced against a target utility of the vehicles.

From a general standpoint, the configurations also show how a modular design for an LSV may provide massive reconfigurability according to one or more sustainability criteria sets with minimal to no loss of utility. Further, such reconfigurability increases sustainability in general without requiring multiple vehicles for specific uses (e.g., delivery, utility, maintenance, etc.). From a weight perspective, the different configurations of the bed guards reduce vehicle weight by use of different materials (e.g., aluminum, hollow tubes, canvas, bamboo, etc.). From an environmental impact perspective, the materials (e.g., bamboo, aluminum, etc.) may also have increased recyclability, increased ability to be composted, reusability, upcycle, or other features. Still further, the configurations have different forms of utility, which may impact the measured values in a sustainability vector.

Starting with configuration 610 of FIG. 6A, consider the bed of the illustrated LSV. The bed, as illustrated, comprises a modular rail guard system deployed around the bed of the LSV. There are multiple points of note with respect to the sustainability of configuration 610. More specifically, the material used is aluminum, which has a high reusability or recyclability. Thus, corresponding measured values for the rail guard system may be assigned to one or more dimensions of the sustainability vector. For example, the vector dimensions may include the following as described in a hierarchical namespace for measurable traits with corresponding values:
LSV.bed.guard::TRUE
LSV.bed.guard.material::“Aluminum”
LSV.bed.guard.material.recyclable::TRUE
LSV.bed.guard.weight::“50 kg”
LSV.bed.guard.modular::TRUE
LSV.bed.guard.modular.reconfigurable::FALSE

The above example includes several illustrative points of discussion. Note, the Boolean value of “TRUE” indicates the feature is present and that other values may also be present (or not present if “FALSE”). Thus, one should appreciate that values of the measured values may take on any practical form of digital data (e.g., Boolean, text, numerical values, time, location, data structures, XML data, YAML data, JSON data, etc.). Further, note as an example, while the guard is modular, it may not be reconfigurable, which could be less desirable from a sustainability perspective according to defined sustainability criteria. Still further, the weight value of 50 kg by itself may be considered low; from an overall weight of the LSV perspective the added weight of the guard may cause the LSV's full weight to fails satisfaction of the sustainability criteria. Thus, one should appreciate the various options available for the LSV provide opportunities to the stakeholders to vary the design early on in the development process of the LSV all the way through to an end-of-life for the LSV.

Consider configuration 615. For the sake of discussion, configuration 615 illustrates a slightly different version of the guard system. In this case, the nearly exact same guard system also provides for reconfiguring the guards into a downward position to permit larger loads to be placed on the bed of the LSV. Thus, the guard system would likely have a different measured value for the “reconfigurable” measurable trait:
LSV.bed.guard.modular.reconfigurable::TRUE

In this scenario, the guard system is now reconfigurable. However, from a sustainability perspective, not much has changed. Still, the utility of the LSV has increased. Therefore, the utility features of the vehicle from a sustainability perspective may be taken into account. More specifically the sustainability criteria may comprise weights for or otherwise factor in utility features of the LSV. In this case, two LSVs with and without a reconfigurable guard system would satisfy the satisfaction criteria. However, the two LSVs would have different satisfaction levels: the LSV with the reconfigurable guard would score higher and would be considered to have a better satisfaction level once utility is factored in.

Scoring or otherwise generating a satisfaction level based on utility features may be performed in many ways. In some cases, a satisfaction level could simply include a count of additional utility features. In other cases, utility features (e.g., tensile strength of materials, density of materials, functionality, load capacity, storage, etc.) may be used to up weight or down weight related measured values. For example, the weight of a feature (e.g., the guard system, etc.) may be divided by a tensile strength to yield a final measured value. In this example, a smaller value may be considered better (i.e., low weight but high tensile strength). Still further, the satisfaction level may include a magnitude (e.g., Euclidian magnitude, Hamming value, etc.) of the sustainability vector for all vector members that satisfy the sustainability criteria, possibly adjusting for weighted values, thereby yielding a single sustainability value or metric for the vehicle. Still, the resulting satisfaction level could be multi-valued.

To continue the discussion with respect to the guard system and sustainability, consider FIG. 6B, which includes two different forms of the guard system. Configuration 620 is very similar to configuration 610 from FIG. 6A; however, rather than using just aluminum for the entire guard assembly other materials are also used. The tubing of the assembly remains aluminum, but the walls are replaced with flexible straps (e.g., canvas straps, nylon straps, etc.). The advantage of this configuration from a sustainability perspective is the weight of the guard is reduced, with minimal cost to utility. Still, the straps may not be as robust against shifting loads in the bed. The measured values for such a configuration may change from the above as follows to indicate a better sustainability:
LSV.bed.guard::TRUE
LSV.bed.guard.material::“Aluminum”
LSV.bed.guard.material::“Nylon”
LSV.bed.guard.material.recyclable::PARTIAL
LSV.bed.guard.weight::“30 kg”
LSV.bed.guard.modular::TRUE
LSV.bed.guard.modular.reconfigurable::TRUE

Note the changes to the vector's values. Nylon has been added as a material and the recyclable value is now “PARTIAL” indicating that some of the materials are recyclable, while some are not (i.e., nylon). Still further, the weight of the guard system has been reduced, thereby increasing sustainability, at least in some circumstances.

While the cross-hatch straps may be sustainable for many purposes, they may not provide full utility or full sustainability as required. Configuration 630 replaces the straps with canvas sides. There are two main points of note. First, canvas may be compostable due to its composition of organic material (e.g., cotton, linen, etc.). Second, while it may weigh marginally more, it provides greater utility in containing cargo. Now, the sustainability vector values could be:
LSV.bed.guard::TRUE
LSV.bed.guard.material::“Aluminum”
LSV.bed.guard.material::“Canvas”
LSV.bed.guard.material.recyclable::TRUE
LSV.bed.guard.material.compostable::TRUE
LSV.bed.guard.weight::“33 kg”
LSV.bed.guard.modular::TRUE
LSV.bed.guard.modular.reconfigurable::TRUE

Now the vector reflects the slight increase in weight while also including a new feature indicating that the materials include some compostable items, which may impact a final satisfaction level of the LSV.

FIG. 6C also includes two additional configurations of the guard system. Of particular note, configuration 640 replaces the wall material with bamboo, which is a biodegradable, low weight, high strength natural material. Bamboo on average has a density of about 0.04 g/cm³ and a yield strength of about 142 Mpa. Aluminum has a density of 2.7 g/cm³ and a yield strength of about 276 Mpa. Other alloys beyond pure aluminum are available and would have different values. However, as may be seen from these values, bamboo's yield strength per unit weight is much higher than that of aluminum. Thus, in some scenarios, bamboo could be a superior choice for sustainability relative to aluminum. Still further, bamboo is considered to have a more pleasing visual appearance for contexts where the LSV could be deployed in public settings. Where mechanical properties of bamboo may be readily measured, subjective terms such as “pleasing” may be more difficult to quantify. Still, such terms may be quantified by surveying individuals that may be impacted by the LSV leveraging bamboo. For example, individuals could be surveyed to rate the “pleasing” nature of the bamboo on the LSV on a scale from 1 (not pleasing) to 5 (very pleasing), or any practical scale. The resulting sustainability vector for the guard system could become:
LSV.bed.guard::TRUE
LSV.bed.guard.material::“Aluminum”
LSV.bed.guard.material::“Bamboo”
LSV.bed.guard.material.recyclable::TRUE
LSV.bed.guard.material.biodegradable::TRUE
LSV.bed.guard.pleasing::4
LSV.bed.guard.weight::“40 kg”
LSV.bed.guard.modular::TRUE
LSV.bed.guard.modular.reconfigurable::TRUE

In this vector, the weight has increase to accommodate the increased weight of the bamboo, but also includes an indication the guard has features that are biodegradable. Still further, the vector includes an indication of a result of a survey regarding how “pleasing” the guard system is, possibly based on a survey of expert, users, owners, observers in a context, or other people. Again, while the discussion with respect to FIG. 6A through 6B is with respect to the guard system, one should keep in mind the whole LSV may be considered.

Configuration 650 presents another possible configuration based on an all-aluminum design. In this scenario, the walls of the guard assembly are aluminum, but have cut outs that reduce the overall weight, possibly at the expense of utility.

FIG. 6D also presents additional guard assembly configurations. Configuration 660 illustrates a combination of configuration 620 and configuration 630. In such cases, the material members of the sustainability vector would increase to include aluminum, canvas, and nylon to account for the more complex assembly.

Configuration 670 add several additional features. In this configuration, the wall material is canvas similar to configuration 630. However, the side walls now have canvas storage bags on the outside of the walls. While this configuration may have an all-canvas construction, with de minimus increase in weight, the utility has increased substantially due to the storage containers for items such as tools, equipment, food, water, or other items. Thus, the use of canvas could be up weighted according to the utility of the storage. In this case, the utility weighting factor of the storage containers could be based on one or more of the amounts of storage provided (e.g., m³, etc.), the number of storage containers, or other quantifiable value.

The discussion with respect to FIGS. 6A through 6D reference several different materials and configurations. Beyond use of aluminum, steel, bamboo, nylon, and canvas, additional materials are also contemplated. In some embodiments, low weight carbon fiber or carbon composites or honeycombed composites may be used. Aluminum sheets could also be pattern-perforated to reduce weight or provide aesthetic patterns that better match an owner's brand (e.g., use a logo design as a hole design, etc.). Still further, although not shown, subject to weight requirements or utility requirements, the surfaces of the vehicles may be covered with solar panels (see URL www.westhillinnovation.com for a suitable source for such solar panels). Such panels may be placed on the roof of the vehicle or bed for example. From an interior perspective, solid seats may be replaced with mesh (e.g., polymer composites, etc.), which may provide for cooler seats in warm weather or offer fast cleaning via a hose. Such seats will have reduced weight and dry faster after cleaning.

Beyond the discussion presented above, there are a quite a few additional considerations that may be appreciated. For example, the above discussion mainly focused on electric ground based LSVs. However, the disclosed subject matter may also be useful for other types of vehicles, possibly including boats, ships, planes, drones, or other vehicles (manned or unmanned). Consider an example based on a boat. A boat's sustainability criteria and associated sustainability vectors may have some similarities to that of an LSV (e.g., use of fuel, use of paints with respect to toxicity, speed management, etc.). However, boats may also have dimensions in the sustainability trait space that do not exist for the LSV use-case. More specifically a boat's sustainability trait space may include dimensions for water displacement, wake, underwater noise, or other features. Each of these would also have corresponding measurable values that may factor into the boat's satisfaction level of the boat's context sustainability criteria. As may be appreciated from this boat example, a sustainability trait space may be defined for specific types of vehicles, specific uses, or for other circumstances. The construction of such sustainability trait spaces may be in addition to or complementary to context specific sustainability criteria discussed above.

Consider the boat example in more detail. Boats or other water vessels provide an even more robust example of how sustainability should be juxtaposed against utility. In view that boats are used on water, they obviously have an impact directly on water-based ecosystems. For example, oils, fuel, or other toxins may leak in the water, which in turn may poison flora and fauna in the water-based ecosystem or habitats. Further, underwater noise may impact wildlife (e.g., whales, porpoises, etc.) that may depend on echolocation or other auditory features for survival. Thus, from a sustainability perspective it would be highly desirable to reduce, minimize, or mitigate the negative impact of such vessels on the environment in order to maximize sustainability while respecting the necessary utility of the vessel.

As indicated above, boats may accidently leak toxins into the water. Rather than using toxic materials (e.g., hydraulic fluids, fuels, paints, etc.), the materials may be replaced with suitable alternatives. Similar to LSVs, instead of using hydraulic fluids, the hydraulic systems may be replaced with air-based hydraulics. Thus, the sustainability increases without loss to utility. This example naturally depends on the target use-case as well. Fuel may be replaced by using batteries and electric motors. While this may eliminate fuel leaks, still the type of battery could impact sustainability. For example, a lead-acid battery may be less sustainable than a Li-Ion battery or other type of battery. Interestingly, such sustainability features may be quantified by comparing the sustainability measures of such factors relative to (e.g., ratio, etc.) a desired efficiency of the boat (e.g., fuel or charge per mile per ton, etc.).

From the perspective of the hull, it is desirable to include anti-hull fouling cover to reduce the growth of marine life in order to ensure the surfaces, propellers, rudders, and the like remain efficient. For example, as these surfaces become fouled, the boat experiences excessive drag or reduced performance thereby limiting the utility of the vessel. Thus, use of less toxic paint or surface covers must be balanced against the utility. More specifically, the disclosed techniques provide for monitoring the operational behavior of the vessel, even in real-time, and then generating recommendations based on observed sustainability satisfaction levels to recommend maintenance on the vessel. Said differently, while less toxic paints may be used, the vessel may require more frequent maintenance.

The above examples with respect to the boats or water vessels are focused on specific traits (e.g., paint, fuel, hydraulics, etc.) relative to utility. However, one should appreciate the whole vessel may be considered in totality. Therefore, while toxic paint or other surface coverings may have a negative impact on sustainability, the impact may be minor relative to the gain of sustainability due to increasing fuel efficiency, decreasing fuel consumption, or even reduce exhaust emissions.

From a more practical perspective, a sustainability vector for a boat may have a different hierarchy or encoding than an LSV or other ground-based vehicle. While some of the trait dimensions may be the same, other non-overlapping trait dimensions may be present. For example, the following portion of a sustainability vector could be used to represent a boat:
boat.hull.material::“Fiberglass”
boat.capacity::5
boat.catagory::“C (In Shore)”
boat.power::“Sail”
boat.coating.paint.type::“Enamel”
boat.coating.paint.type::“No VOC”
boat.coating.paint.type::“Non-Leaching”

The example boat sustainability vector provides several additional points of note. First, the sustainability vector illustrates the trait space includes boat specific features such as hull material and category. For example, the hull material may have a material impact on water habitats. Therefore, “Fiberglass” may not be as sustainable as aluminum in view that fiberglass may leave small particulates in the water. Second, as mentioned previously, other traits from the boat as a whole may compensate for the choice of material. In this example, the boat is a sailboat, which indicates the there are no emissions. Third, the example boat leverages an enamel paint with no Volatile Organic Compounds (VOCs), indicating the paint will give off little harmful gases. Further, the paint type is characterized by at least one additional feature “Non-Leaching” indicating little to no harmful compounds will leach into the water. Thus, in aggregate, the boat characterized by the example sustainability vector may have an acceptable satisfaction level.

As discussed above, a sustainability trait space could have any practical number of dimensions. Still, the number of dimensions may be quite large. However, there are a couple of dimensions that could bear further discussion, especially at they relate to the human senses. Consider a dimension that relates to noise. A noise or auditory dimension could be included to quantify how humans may react to the noise a vehicle makes from a subjective perspective. However, such a dimension also has practical value and may have an impact on nature. Thus, noise abatement may be an objectively measured trait with respect to how the noise of the vehicle may disturb wildlife for example. The degree to which a corresponding measured value for noise satisfies sustainability criteria may depend on speed, location, type of wildlife, or other factors. As discussed above these factors may be quantified based on the vessel's sustainability trait space and corresponding satisfaction level.

One or more visual dimensions may also be included in a sustainability trait space as discussed previously. In some embodiments, computer vision techniques may be used to observe an operating environment of a vehicle or vessel. Through the use of one or more implementations of computer vision algorithms (see OpenCV.org for example), a computer (e.g., computer-based sustainability validation system in FIG. 4) may generate recommendations for the vehicle's physical design or coverings (e.g., paint, decals, etc.) that better match the operating environment. For example, edge detection (e.g., Canny edges, etc.) may be used to determine a number of edges in particular directions; perhaps vertical edges or horizontal edges. In response, a recommendation could include a suggested covering pattern that has corresponding or similar number of edges. Such an approach may be extrapolated readily to include additional image features beyond edges including color, image descriptors, textures, patterns, camouflage, or other factors. Corresponding satisfaction criteria may require the number of computer-vision based observable features (e.g., descriptors, textures, edges, curves, etc.) to fall within ranges or to satisfy corresponding criteria that seek to blend with the curves or features of the natural environment. Such an approach is also considered advantageous because it provides for using computer-based techniques to identify visual aspects that could reduce how much a vehicle may disturb an environment or wildlife. Further, identification of the visual aspects of a vehicle aids in ensuring the vehicle blends into the background, if desirable. Even further, such techniques may be quite useful in embodiments where the vehicle's surfaces are covered with LED panels that may render desirable images that blend better into the environment.

Additional dimensions of a sustainability trait space may include olfactory dimensions, cultural dimensions, flora or fauna related dimensions, personal or individual related dimensions, commercial dimensions, religious dimensions, or other dimensions that may be leveraged to reduce an impact on an operating environment or to ensure other entities (e.g., animals, fish, people, etc.) are less disturbed. Still further, consider electromagnetic dimensions. In some embodiments, electromagnetic emissions could be controlled via use of Faraday cages to reduce electromagnetic noise. In addition, there may be thermal dimensions that may be controlled via active cooling to ensure there are no “hot-spot” on the vehicle or in the environment due to the presence of the vehicle. For example, a vehicle that is running hot may not be permitted to stay in a single location for too long to prevent the vehicle from thermally damaging the local flora or fauna.

The inventive subject matter provides many advantages as discussed above. One specific advantage may not be so apparent, while it is inherent in the described technology. More specifically, by abstracting and/or encoding a vehicle's sustainability according to a trait space, the sustainability of the vehicle may be easily managed separate from or independent of the utility of the vehicle. This means, sustainability may be largely decoupled from the mere design of the vehicle. Such a decoupling allows for monitoring or otherwise managing the sustainability at any point in time while also accounting for the utility of the vehicle. Further, the decoupling provides for context-specific or domain-specific sustainability as described.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

1. A vehicle, comprising:
a plurality of measurable traits; and
a sustainability vector having a plurality of sustainability dimensions and having stored measured values from the vehicle for the at least some of the plurality of measurable traits for the plurality of sustainability dimensions,
and
a validation computer system configured to:
receive, from one or more sensors, one or more measured values for one or more of the plurality of measurable traits of the vehicle in a first sustainability context having a first noise tolerant level, wherein the one or more of the plurality of measurable traits include noise;
detect that the vehicle moves from the first sustainability context to a second substantiality context having a second noise tolerant level different from the first noise tolerant level;
receive, from the one or more sensors, one or more updated measured values for the one or more of the plurality of measurable traits including noise in the second sustainability context; and
control, based on the one or more updated measured values and a priori defined sustainability criteria associated with the second substantiality context including the second noise tolerant level, one or more components of the vehicle including at least a noise reducing device, such that the sustainability vector satisfies the priori defined sustainability criteria.

2. The vehicle of claim 1, wherein the plurality of measurable traits comprises one or more of the following types of traits: physical traits, visual traits, auditory traits, functional traits, thermal traits, electromagnetic traits, emissions traits, wake traits, and toxicity traits.

3. The vehicle of claim 1, wherein at least two measurable traits of the vehicle are correlated traits.

4. The vehicle of claim 1, wherein at least two measurable traits of the vehicle are non-correlated traits.

5. The vehicle of claim 1, wherein the sustainability vector adheres to an a priori defined namespace.

6. The vehicle of claim 1, wherein the sustainability vector adheres to an a priori defined ontology.

7. The vehicle of claim 1, wherein the sustainability vector adheres to an a priori defined standard.

8. A computer-based vehicular sustainability validation system comprising:
at least one computer readable memory storing a plurality of measurable traits of a vehicle and validation software instructions; and
at least one processor coupled with the memory and configured, upon execution of the validation software instructions, to conduct operations including:
obtaining stored measured values for at least some measurable traits of the plurality of measurable traits of the vehicle;
generating in the at least one memory a sustainability vector having a plurality of sustainability dimensions as a function of the stored measured values for the at least some measurable traits;
obtaining sustainability criteria that operates on the sustainability vector;
determining a satisfaction level according to the sustainability criteria operating on the sustainability vector;
detecting that the vehicle moves from a first sustainability context to a second substantiality context having a second noise tolerant level different from a first noise tolerant level of the first sustainability context;
receiving, from one or more sensors, one or more updated measured values for the one or more of the plurality of measurable traits including noise in the second sustainability context; and
controlling one or more components of the vehicle including at least a noise reducing device, such that the sustainability vector satisfies the priori defined sustainability criteria.

9. The system of claim 8, wherein the satisfaction level represents the vehicle satisfies the sustainability criteria, and
wherein the one or more performance characteristics of the vehicle are associated with a tire pressure, a speed, or noise of the vehicle.

10. The system of claim 8, wherein the sustainability vector is used to characterize a physical vehicle.

11. The system of claim 8, wherein the operations further include providing a certification of satisfaction of the sustainability criteria.

12. The system of claim 9, herein the satisfaction level represents a degree of satisfaction.

13. The system of claim 8, wherein the satisfaction level represents the vehicle does not satisfy the sustainability criteria.

14. The system of claim 13, wherein the operations include causing an output device to generate a notification relating the satisfaction level, and
wherein the notification includes a recommended adjustment to at least one of the measurable traits of the vehicle.

15. The system of claim 13, wherein the automatically adjusting one or more performance characteristics of the vehicle includes:
adjusting at least one of the measurable traits of the vehicle to better align with the sustainability criteria, wherein the at least one of the measurable traits are associated with the one or more performance characteristics.

16. The system of claim 15, wherein the operation of adjusting at least one of the measurable traits occurs in real-time.

17. The system of claim 14, wherein the notification includes a recommended adjustment to at least one of the measurable traits of the vehicle.

18. The system of claim 8, wherein the plurality of measurable traits comprises one or more of the following types of traits: physical traits, visual traits, auditory traits, functional traits, thermal traits, electromagnetic traits, emissions traits, wake traits, and toxicity traits.

19. The system of claim 8, wherein at least two measurable traits of the vehicle are correlated traits.

20. The system of claim 8, wherein at least two measurable traits of the vehicle are un-correlated traits.

21. The system of claim 8, wherein the sustainability vector adheres to an a priori defined namespace.

22. The system of claim 8, wherein the sustainability vector adheres to an a priori defined ontology.

23. The system of claim 8, wherein the sustainability vector adheres to an a priori defined standard.

24. The system of claim 8, wherein the sustainability criteria depend on a magnitude of the sustainability vector.

25. The system of claim 8, wherein the sustainability criteria depend on a defined volume in a space defined by the plurality of sustainability dimensions.

26. The system of claim 14, wherein the output device comprises the vehicle.

27. The system of claim 14, wherein the notification comprises at least one of the following: a call to an Application Programming Interface (API), a remote procedure call (RPC), a digitally displayed message, a dashboard update, an email, a phone call, and a network communication.
